(19) United States
(12) Patent Application Publication
(10) Pub. No.: US 2022/0398551 A1
(43) Pub. Date: Dec. 15, 2022

(54) WORKER SELECTION SYSTEM, WORKER SELECTION METHOD, NON-TRANSITORY COMPUTER-READABLE STORAGE MEDIUM

(71) Applicant: SEIKO EPSON CORPORATION, Tokyo (JP)

(72) Inventors: Chiaki SHIMADA, SHIOJIRI-SHI (JP); Kohei UENO, MATSUMOTO-SHI (JP)

(21) Appl. No.: 17/806,640

(22) Filed: Jun. 13, 2022

(30) Foreign Application Priority Data
Jun. 14, 2021 (JP) 2021-098579

(51) Int. Cl. G06Q 10/00; G06Q 10/06

(52) U.S. Cl. CPC G06Q 10/20; G06Q 10/063112; G06Q 10/063114

(57) ABSTRACT

In a worker selection system that selects a worker who performs restoration work on a device that failed, the system includes a failure information reception unit that receives failure information including information about a content of the failure and information about an identification of the device, a worker information storage unit that stores worker information including information about a failure handling ability of the worker and information about a location of the worker, an area information storage unit that stores area information about a setting area including a location of the device and changing depending on a setting, and a worker selection unit that selects, based on the worker information and the area information, the worker who has an ability to handle the failure and is present in the setting area as a candidate to be dispatched.

The present application is based on, and claims priority from JP Application Serial Number 2021-098579, filed Jun. 14, 2021, the disclosure of which is hereby incorporated by reference herein in its entirety.

### BACKGROUND

### 1. Technical Field

The present disclosure relates to a worker selection system that selects a worker who performs restoration work on a device that failed, a worker selection method of selecting a worker who performs restoration work on a device that failed, and a non-transitory computer-readable storage medium storing a worker selection program, where the program cause a computer to select a worker who performs restoration work on a device that failed.

### 2. Related Art

In the related art, a system for dispatching a worker to a device in which a failure has occurred has been known. For example, in JP-A-2006-106861 discloses the technology for selecting and determining a worker by taking into consideration the distance between the location of the worker and the location of the work base where the device in which the failure has occurred is present, the experience of the worker, and the like to instruct the worker who can solve the customer's trouble faster to handle the trouble.

In recent years, from the viewpoint of infectious disease countermeasures, for example, it may be unfavorable for people to come and go across prefectural borders. Under these circumstances, a user of a device that failed may not want the worker to be dispatched from a specific area. In addition to the restriction from the viewpoint of infectious disease countermeasures, for example, a device manufacturer may want to manage the dispatch source area of workers. However, the worker selection system in the related art does not consider such a problem.

### SUMMARY

According to an aspect of the present disclosure, a worker selection system of the present disclosure is a worker selection system that selects a worker who performs restoration work on a device that failed, where the system includes a failure information reception unit that receives failure information including information about a content of the failure and information about an identification of the device, a worker information storage unit that stores worker information including information about a failure handling ability of the worker and information about a location of the worker, an area information storage unit that stores area information about a setting area including a location of the device and changing depending on a setting, and a worker selection unit that selects, based on the worker information and the area information, the worker who has an ability to handle the failure and is present in the setting area as a candidate to be dispatched.

According to another aspect of the present disclosure, a worker selection method is a worker selection method of selecting a worker who performs restoration work on a device that failed, where the method includes receiving failure information including information about a content of the failure and information about an identification of the device, and selecting, based on worker information including information about a failure handling ability of the worker and information about a location of the worker, and area information about a setting area including a location of the device and changing depending on a setting, the worker who has an ability to handle the failure and is present in the setting area as a candidate to be dispatched.

According to still another aspect of the present disclosure, in a non-transitory computer-readable storage medium storing a worker selection program, the program causes a computer to select a worker who performs restoration work on a device that failed, and causes the computer to execute a method, where the method includes receiving failure information including information about a content of the failure and information about an identification of the device, and selecting, based on worker information including information about a failure handling ability of the worker and information about a location of the worker, and area information about a setting area including a location of the device and changing depending on a setting, the worker who has an ability to handle the failure and is present in the setting area as a candidate to be dispatched.

### BRIEF DESCRIPTION OF THE DRAWINGS

FIG. 1 is a block diagram of a worker selection system.

FIG. 2 is a diagram showing an example of a failure restoration condition table.

FIG. 3 is a diagram showing an example of a worker basic table, a worker ability table, and a current status table.

FIG. 4 is a diagram showing an example of a setting area table.

FIG. 5 is a flowchart showing a process by a failure analysis unit in a device of a user.

FIG. 6 is a flowchart showing a process by a handling determination unit in a manufacturer management server.

FIG. 7 is a flowchart showing a process by a worker selection unit in a worker selection server.

FIG. 8 is a diagram conceptually showing a positional relationship between a failure-generating device and a selected worker.

FIG. 9 is a diagram conceptually showing a positional relationship between a failure-generating device and a selected worker.

### DESCRIPTION OF EXEMPLARY EMBODIMENTS

Hereinafter, the present disclosure will be schematically described. A worker selection system according to a first aspect is a worker selection system that selects a worker who performs restoration work on a device that failed, where the system includes a failure information reception unit that receives failure information including information about a content of the failure and information about an identification of the device, a worker information storage unit that stores worker information including information about a failure handling ability of the worker and information about a location of the worker, an area information storage unit that stores area information about a setting area including a location of the device and changing depending on a setting, and a worker selection unit that selects, based on the worker information and the area information, the worker who has an ability to handle the failure and is present in the setting area as a candidate to be dispatched.

According to this aspect, the worker selection system select, based on worker information including information about a failure handling ability of the worker and information about a location of the worker, and area information about a setting area that includes a location of the device that failed and that changes depending on the setting, the worker who has an ability to handle the failure and is present in the setting area as a candidate to be dispatched, so that it is possible to suppress the dispatch of the worker from an area unfavorable to the user of the device, the manufacturer of the device, or the like, and it is possible to dispatch a suitable worker.

In a second aspect according to the first aspect, the worker includes a manufacturer worker who belongs to the manufacturer of the device and a non-manufacturer worker who does not belong to the manufacturer of the device.

According to this aspect, the worker includes a manufacturer worker who belongs to the manufacturer of the device and a non-manufacturer worker who does not belong to the manufacturer of the device, so that it is possible to select a candidate to be dispatched from a larger number of workers and as a result, a more appropriate worker can be selected.

In a third aspect according to the second aspect, when the non-manufacturer worker present in the setting area is allowed to handle the failure by receiving remote support, the worker selection unit selects the non-manufacturer worker as the candidate to be dispatched. According to this aspect, when the non-manufacturer worker present in the setting area is allowed to handle the failure by receiving remote support, the worker selection unit selects the non-manufacturer worker as the candidate to be dispatched, so that the non-manufacturer worker can be a candidate to be dispatched by supplementing the failure handling ability of the non-manufacturer worker, and the range of worker selection can be expanded.

In a fourth aspect according to the third aspect, the worker selection server including the worker selection unit is allowed to transmit information about the worker selected as the candidate to be dispatched to an information terminal of a user who is a user of the device, and the information about the worker to be transmitted to the information terminal of the user includes a remark indicating that the worker receives remote support.

When the worker receives remote support, the worker may image the surroundings of the device by using the camera, so that the imaging may be unfavorable for the user of the device in terms of security. However, according to this aspect, the information about the worker transmitted by the worker selection server to the information terminal of the user includes a remark indicating that the worker receives remote support, so that the user who does not like the remote support can be notified of the remark, and it is possible to take the intention of the user into consideration.

In a fifth aspect according to any one of the first to fourth aspects, the setting area is an area set for infectious disease countermeasures. According to this aspect, since the setting area is an area set for infectious disease countermeasures, it is possible to select the appropriate worker from the viewpoint of infectious disease countermeasures.

A worker selection method according to a sixth aspect is a worker selection method of selecting a worker who performs restoration work on a device that failed, where the method includes receiving failure information including information about a content of the failure and information about an identification of the device, and selecting, based on worker information including information about a failure handling ability of the worker and information about a location of the worker, and area information about a setting area including a location of the device and changing depending on a setting, the worker who has an ability to handle the failure and is present in the setting area as a candidate to be dispatched.

According to this aspect, the worker selection method includes selecting, based on worker information including information about a failure handling ability of the worker and information about a location of the worker, and area information about a setting area that includes a location of the device that failed and that changes depending on the setting, the worker who has an ability to handle the failure and is present in the setting area as a candidate to be dispatched, so that it is possible to suppress the dispatch of the worker from an area unfavorable to the user of the device, and it is possible to dispatch a suitable worker.

A worker selection program according to a seventh aspect is a worker selection program causing a computer to select a worker who performs restoration work of a device that failed, and causing the computer to execute a method, where the method includes receiving failure information including information about a content of the failure and information about an identification of the device, and selecting, based on worker information including information about a failure handling ability of the worker and information about a location of the worker, and area information about a setting area including a location of the device and changing depending on a setting, the worker who has an ability to handle the failure and is present in the setting area as a candidate to be dispatched.

According to this aspect, the worker selection program include a method, where the method includes selecting, based on worker information including information about a failure handling ability of the worker and information about a location of the worker, and area information about a setting area that includes a location of the device that failed and that changes depending on the setting, the worker who has an ability to handle the failure and is present in the setting area as a candidate to be dispatched, so that it is possible to suppress the dispatch of the worker from an area unfavorable to the user of the device, and it is possible to dispatch a suitable worker.

Hereinafter, the present disclosure will be specifically described. In the following, as an embodiment of the present disclosure, a worker selection system 50 will be described in which a device to be restored is set as a recording device 1, and a worker who performs the restoration work of the recording device 1 when a failure occurs in the recording device 1 is selected. An examples of the recording device 1 includes an ink jet printer that performs recording by ejecting ink, which is an example of a liquid, onto recording paper, which is an example of a medium. The worker selection system 50 according to the embodiment includes a manufacturer management server 10 and a worker selection server 20. Of course, the worker selection system 50 is not limited to such a configuration. For example, the manufacturer management server 10 and the worker selection server 20 may be the same server, or worker data 25 and area information data 26 included in the worker selection server 20 may be included in another server. Such a modification will be described later.

In order to explain the functions of the worker selection system 50, the recording device 1, a user terminal 40, and a worker terminal 30 will be described in addition to the worker selection system 50. The recording device 1, the manufacturer management server 10, the worker selection server 20, the user terminal 40, and the worker terminal 30 are connected to a network 100 such as the Internet, and information can be transmitted and received between the any devices. Hereinafter, the configuration of respective devices will be described.

### Recording Device

The recording device 1 includes a recording mechanism unit 5. The recording mechanism unit 5 includes an ink ejection head (not shown) for ejecting ink and a transporting unit (not shown) that transports recording paper. Further, the recording device 1 includes a controller 2, a display unit 3, an input unit 4, and a storage unit 6. The controller 2 includes a CPU, a volatile memory, a communication module, and the like (not shown). The controller 2 controls respective units, including the recording mechanism unit 5, of the recording device 1 by execute various control programs stored in the storage unit 6, and also transmits/receives information to/from an external device. The storage unit 6 includes a nonvolatile memory such as a flash memory. A failure analysis unit 7 is one of the programs stored in the storage unit 6, and is executed by the controller 2. The failure analysis unit 7 will be described later. The display unit 3 includes a liquid crystal panel and displays various pieces of information. The input unit 4 includes various setting buttons, and the user performs various operation settings of the recording device 1 via the input unit 4.

### Manufacturer Management Server

The manufacturer management server 10 is a computer terminal including a controller 11, a display unit 12, an input unit 13, and a storage unit 14. The manufacturer management server 10 is, for example, a computer terminal owned and managed by a manufacturer A of the recording device 1. The controller 11 includes a CPU, a volatile memory, a communication module, and the like (not shown). The controller 11 executes various programs stored in the storage unit 14 and also transmits/receives information to/from an external device. The storage unit 14 includes a storage such as a hard disk. A handling determination unit 16 is one of the programs stored in the storage unit 14, and is executed by the controller 11. Further, the storage unit 14 stores restoration condition data 15. The handling determination unit 16 and the restoration condition data 15 will be described later. The display unit 12 includes a liquid crystal display and displays various pieces of information. The input unit 13 includes a keyboard and a mouse (not shown), and an operator belonging to the manufacturer A can input various pieces of information via the input unit 13.

### Worker Selection Server

The worker selection server 20 is a computer terminal including a controller 21, a display unit 22, an input unit 23, and a storage unit 24. The worker selection server 20 is, for example, a computer terminal owned and managed by a worker dispatching company D. The worker dispatching company D is a different from the manufacturer A. However, it goes without saying that the worker selection server 20 may be a computer terminal owned and managed by the manufacturer A of the recording device 1.

The controller 21 includes a CPU, a volatile memory, a communication module, and the like (not shown). The controller 21 executes various programs stored in the storage unit 24, and also transmits/receives information to/from an external device. The storage unit 24 includes a storage such as a hard disk. A worker selection unit 27 is one of the programs stored in the storage unit 24, and is executed by the controller 11. Further, the storage unit 24 stores the worker data 25 and the area information data 26. The worker selection unit 27, the worker data 25, and the area information data 26 will be described later. The display unit 22 includes a liquid crystal display and displays various pieces of information. The input unit 23 includes a keyboard and a mouse (not shown), and an operator belonging to the worker dispatching company D can input various pieces of information via the input unit 23.

### Worker Terminal

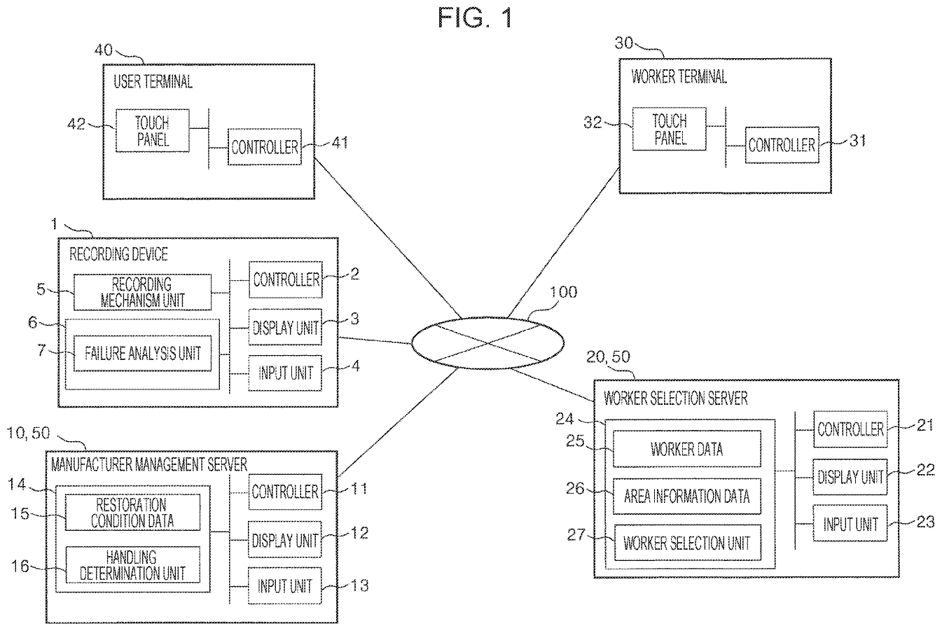

The worker terminal 30 is a mobile information terminal including a controller 31 and a touch panel 32, for example, a smartphone. The controller 31 includes a CPU, a volatile memory, a nonvolatile memory, a communication module, and the like (not shown). The controller 31 executes various programs stored in the nonvolatile memory, and also transmits/receives information to/from an external device. The touch panel 32 displays various pieces of information and accepts various input operations. For convenience of illustration, only one worker terminal 30 is shown in FIG. 1, but practically, each of a plurality of workers has one worker terminal 30.

### User Terminal

The user terminal 40 is a mobile information terminal including a controller 41 and a touch panel 42, for example, a smartphone, which is owned by the user of the recording device 1. The controller 41 includes a CPU, a volatile memory, a nonvolatile memory, a communication module, and the like (not shown). The controller 41 executes various programs stored in the nonvolatile memory, and also transmits/receives information to/from an external device. The touch panel 42 displays various pieces of information and accepts various input operations. Process by recording device when a failure occurs

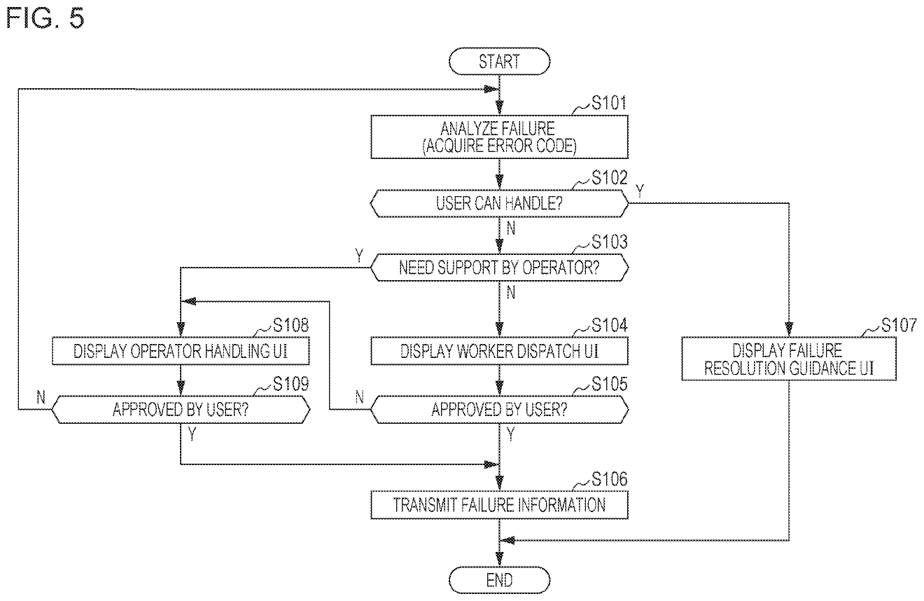

Subsequently, a process for the recording device 1 when a failure occurs in the recording device 1 will be described with reference to FIG. 5. FIG. 5 shows the flow of the process when the controller 2 of the recording device 1 executes the failure analysis unit 7. When a failure occurs in the recording device 1, the controller 2 of the recording device 1 analyzes the content of the failure and acquires the corresponding error code (step S101). The storage unit 6 of the recording device 1 stores the contents of the failure and the error code corresponding to the contents as data, and the controller 2 acquires the error code by referring to this data. Failure analysis is performed using various sensors provided in the recording device 1 as needed. In addition, the error code is linked with a flag indicating whether the failure can be handled by the user, and a flag indicating whether remote support for the user by the operator or dispatch of a worker is required, and these flags are stored in the storage unit 6. In addition, the error code includes a code that corresponds to a case where the content of the failure is unknown, that is, the failure cannot be analyzed. In this case, remote support for the user by the operator or dispatch of a worker is required.

Next, when the content of the failure is a content which the user can handle (Yes in step S102), for example, when it is determined that the paper is out or the ink is out, the controller 2 displays user interface (hereinafter referred to as “UI”) for guiding the content of a failure and a method of resolving the failure on the display unit 3 of the recording device 1 (step S107). On the other hand, when it is determined that the content of the failure is a content which the user can not handle (No in step S102), for example, it is determined that there is a defect in the electrical system or the life of the part has expired, the process proceeds to step S103. In step S103, it is determined whether the content of the failure is a content which the operator of the manufacturer A is required to handle. An example of the content which the operator of the manufacturer A is required to handle includes a case where the content of the failure cannot be determined in step S101, and the operator has to directly hear the situation of the failure and acquire further information from the user in order to determine whether to dispatch a worker.

When it is determined that the operator is required to handle the failure (Yes in step S103), the controller 2 displays, on the display unit 3 of the recording device 1, the UI that recommends the interaction with the operator (step S108). This UI may be a message indicating, for example, “A failure has occurred. The operator will contact you to resolve the failure. Do you accept it? (Y/N)”. When the user approves this request (Yes in step S109), the controller 2 of the recording device 1 transmits the failure information to the manufacturer management server 10 (step S106). The failure information includes at least the model number and the serial number of the recording device 1, the error code, and the failure occurrence date and time. The error code and the failure occurrence date and time are an example of information about the content of the failure, and the model number and the serial number of the recording device 1 are an example of information about the identification of the device.

When receiving the failure information, the operator of the manufacturer A refers to the company database to call the telephone number registered as the contact of the user of the recording device 1 and hear the user of the recording device 1 about information about the failure from. Then, the operator determines whether it is necessary to dispatch a worker to restore the failure, and when it is necessary to dispatch a worker, determines the ability of the worker required to restore the failure, and transmits the information to the worker selection server 20. This corresponds to the operation to be performed by the handling determination unit 16 to be described later being performed by the operator of the manufacturer A.

Returning to step S103, when it is determined that handling by the operator is not necessary (No in step S103), that is, when the content of the failure is clear and it is necessary to dispatch a worker, the controller 2 displays, on the display unit 3 of the recording device 1, the UI for dispatching the worker (step S104). This UI may be a message indicating, for example, “A failure has occurred. The restoration work by the worker is required to eliminate the failure. Do you accept that the worker is dispatched? (Y/N)”. When the user approves this request (Yes in step S105), the controller 2 of the recording device 1 transmits the failure information to the manufacturer management server 10 (step S106). When the user does not approve the request in step S105, the process proceeds to step S108. Process by manufacturer management server

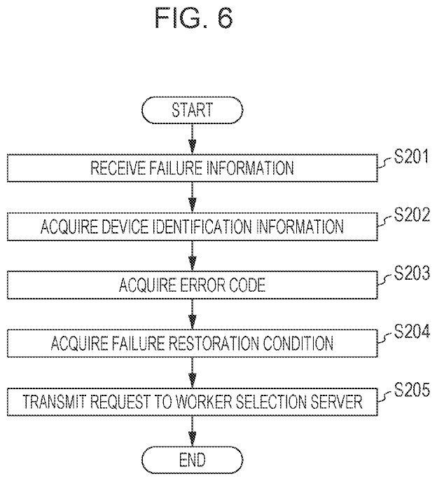

The controller 11 of the manufacturer management server 10 functions as a failure information reception unit that receives failure information including information about the content of the failure and information about the identification of the device. FIG. 6 shows the flow of a process when the controller 11 of the manufacturer management server 10 executes the handling determination unit 16. When the controller 11 receives the failure information (step S201), the controller 11 acquires, from the failure information, information about the identification of the device, that is, the model number and the serial number of the recording device 1 (step S202), and then acquires an error code from the failure information (step S203). Then, the controller 11 acquires the failure restoration condition corresponding to the error code by referring to the restoration condition data 15 (step S204) to transmit a worker selection request to the worker selection server 20 (step S205). The request transmitted by the controller 11 to the worker selection server 20 includes the model number and the serial number of the recording device 1, the error code, the failure occurrence date and time, the location where the recording device 1 is installed, and the failure restoration condition.

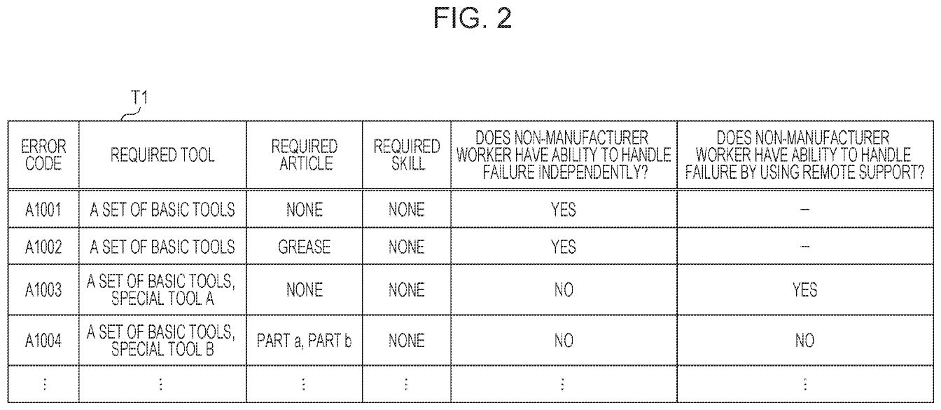

Here, the acquisition of the failure restoration condition (step S204) will be described with reference to FIG. 2 showing a failure restoration condition table T1 which is an example of the restoration condition data 15. The failure restoration condition table T1 shown in FIG. 2 is set for each model number of the recording device 1, and a required tool, a required article, a required skill, and the like for restoring the failure are set for each error code as shown in the figure. The set of basic tools in the required tool includes, for example, tools such as a screwdriver and a plier. Examples of the special tool include a star-shaped screwdriver, a tester, and the like. Examples of the required article include grease, screwing agents, adhesives, and replacement parts for the recording device 1. Examples of the required skill include qualifications such as chief electrical engineer. As an example, in the case of the error code A1004, the table shows that the set of basic tools and a special tool B are required as required tools, replacement parts a and b are required as required articles, and a specific skill is not required. Such a restoration condition table T1 can be appropriately modified and added by the operator of the manufacturer A.

Further, the failure restoration condition table T1 includes information about whether a non-manufacturer worker has an ability to handle the failure or whether a non-manufacturer worker has an ability to handle the failure with remote support. In the embodiment, the workers include a worker who belongs to the manufacturer A, that is, a manufacturer worker who has expertise in the recording device 1, and a worker who does not belong to the manufacturer A, that is, a non-manufacturer worker who does not necessarily have expertise in the recording device 1. When the difficulty level of failure restoration is low, even a non-manufacturer worker can handle the failure, and based on the fact, in the embodiment, it is premised that the non-manufacturer worker is included as the worker. As a result, the degree of freedom of choice of the worker is improved, and the worker can be dispatched more quickly to the place where the failure occurred. As a general rule, only the manufacturer worker can handle the failure when the work requires parts replacement. In addition, when disassembling the device is involved, it is often the case that only the manufacturer worker has an ability to handle the failure. Most of the work other than the above, such as on-site checking, cleaning, adjustment, and the like, can be handled even by a non-manufacturer worker.

Even when a non-manufacturer worker cannot handle a failure independently, the non-manufacturer worker may be able to handle the failure by receiving remote support from the manufacturer worker. For example, in the case of the error code A1003, the non-manufacturer worker cannot perform the failure restoration independently, but can perform the failure restoration by receiving the remote support from the manufacturer worker. Examples of the remote support include text-based support by e-mail, facsimile, and the like, voice-based support by telephone call, voice and video-based support by video call, and the like. In addition, when a non-manufacturer worker has a so-called smart glass, augmented reality (AR), that is, augmented reality technology can be used to provide a perspective of the non-manufacturer worker with information necessary for failure restoration work. Which method is used for remote support depends exclusively on a device possessed by the non-manufacturer worker, where the device is included in the worker data 25 to be described later.

### Process by Worker Selection Server

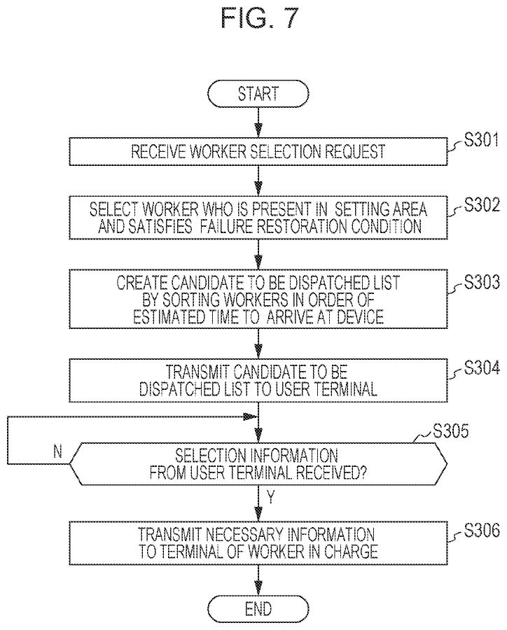

Next, the controller 21 of the worker selection server 20 functions as a request information reception unit that receives, from the manufacturer management server 10, request information, specifically, the model number and the serial number of the recording device 1, the error code, the failure occurrence date and time, the location where the recording device 1 is installed, and the failure restoration condition. FIG. 7 shows the flow of a process when the controller 21 of the worker selection server 20 executes the worker selection unit 27. Here, before explaining the process shown in FIG. 7, the worker data 25 and the area information data 26 stored in the storage unit 24 of the worker selection server 20 will be described. The storage unit 24 of the worker selection server 20 functions as a worker information storage unit that stores worker information including information about a failure handling ability of the worker and information about a location of the worker. Further, the storage unit 24 functions as an area information storage unit that stores area information about a setting area that includes the location of the device having a failure and changes depending on the setting.

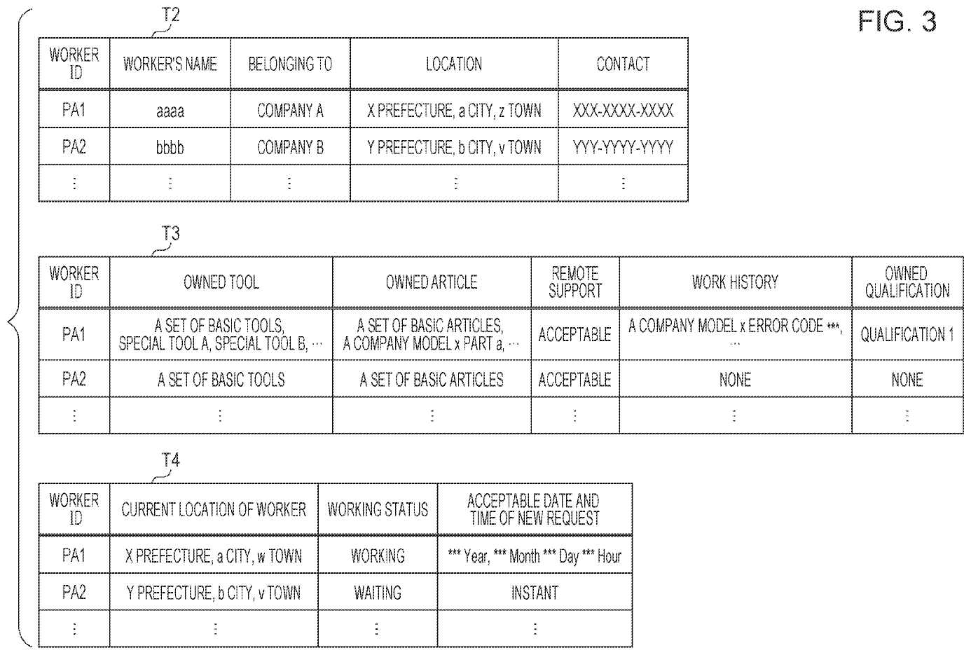

FIG. 3 is an example of the worker data 25 and shows a worker basic table T2, a worker ability table T3, and a current status table T4 that constitute the worker data 25. Of these, the worker ability table T3 includes information about a failure handling ability of the worker, and the worker basic table T2 includes information about a location of the worker. First, basic information about the worker is registered in the worker basic table T2. Specifically, the worker ID, the name of the worker, the company to which the worker belongs, the location (the place where the worker works), and the contact are registered as shown in the figure. The contact also includes, in addition to the telephone number, address information for transmitting information to the worker terminal 30. Further, the tools owned by the worker, the articles owned by the worker, whether remote support can be accepted, the work history, and the qualification owned by the worker are registered in the worker ability table T3 as shown in the figure in association with the worker ID. Since even a manufacturer worker may receive remote support from the company to which the worker belongs, information about whether remote support can be accepted is registered.

Further, the current location of the worker, the operating status, and the date and time when a new request can be accepted are registered in the current status table T4 as shown in the figure in association with the worker ID. The current location of the worker, the operating status, and the date and time when a new request can be accepted are updated from time to time by the worker inputting information into the worker terminal 30 owned by the worker and transmitting the information from the worker terminal 30 to the worker selection server 20. The current location information can be automatically and periodically transmitted to the worker selection server 20 by the worker terminal 30 using a positioning system using a satellite.

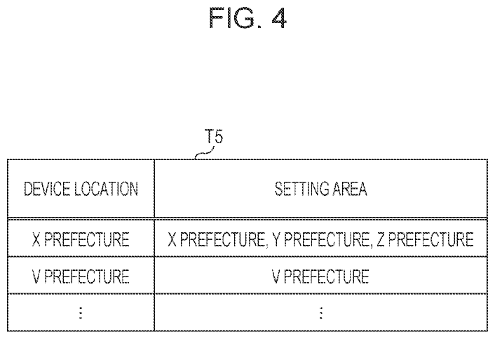

Next, FIG. 4 shows a setting area table T5 which is an example of the area information data 26. The setting area corresponding to the location of the device that failed is registered in the setting area table T5. For example, when the location of the device that failed is in X prefecture, the setting area is X prefecture, Y prefecture, and Z prefecture, so that the workers present in X prefecture, Y prefecture, and Z prefecture are selected as candidates to be dispatched. When the location of the device that failed is in V prefecture, the setting area is V prefecture, so that the workers present in V prefecture will be selected as candidates to be dispatched. The setting area table T5 is appropriately updated by the operator of the manufacturer A or the operator of the worker dispatching company D. For example, when the setting area table T5 is set from the viewpoint of infectious disease countermeasures, it is appropriately updated based on a self-restraint request regarding movement issued by the national or local government according to the spread of infectious diseases.

Next, the flow of a process when the controller 21 of the worker selection server 20 executes the worker selection unit 27 will be described with reference to FIG. 7. When the controller 21 of the worker selection server 20 receives a worker selection request from the manufacturer management server 10 (step S301), the controller 21 selects a worker who is present in the setting area and satisfies the failure restoration condition (step S302). In this selection, as an example, the current status of the worker grasped from the current status table T4 (see FIG. 3) is not inquired, and based on the location of the worker grasped from the worker basic table T2 (see FIG. 3), and the failure handling ability of the worker grasped from the worker ability table T3 (see FIG. 3), a worker who satisfies the failure restoration condition is selected. Instead of the location of the worker grasped from the worker basic table T2 (see FIG. 3), the current location of the worker grasped from the current status table T4 (see FIG. 3) may be used.

Next, the controller 21 of the worker selection server 20 creates a candidate to be dispatched list by sorting selected workers in the order of the shortest estimated time to arrive at the device that failed based on the current status of the worker grasped from the current status table T4 (see FIG. 3) (step S303). The controller 21 calculates the estimated time for the worker to arrive at the device that failed based on the date and time when the worker can accept the new request, which is grasped from the current status table T4 (see FIG. 3), and further in consideration of the standard required time when the worker moves by car to the location of the device that failed from the current location of the worker.

The standard required time can be acquired by using, for example, a known route search system. In the embodiment, the means by which the worker moves is limited to an automobile from the viewpoint of infectious disease countermeasures. However, when the public transport system is available, the means is not limited to this. At this time, the means by which the worker moves may be registered in the worker basic table T2 (see FIG. 3), and the standard required time may be calculated based on the moving means. When using the public transport system, the standard required time can be acquired by using, for example, a known route search system. Then, the controller 21 transmits, to the user terminal 40, the candidate to be dispatched list created (step S304).

The controller 41 of the user terminal 40 displays, on the touch panel 42, the candidate to be dispatched list received. The information displayed on the user terminal 40 includes information about the company to which the worker belongs, the work location of the worker, the estimated visit time, and whether the worker receives remote support. The user of the recording device 1 selects a desired worker from the candidate to be dispatched list displayed on the user terminal 40. In response to this, the user terminal 40 transmits the worker selection information to the worker selection server 20.

When the controller 21 of the worker selection server 20 receives the worker selection information (Yes in step S305), the controller 21 transmits necessary information to the worker terminal 30 owned by the worker in charge (step S306). This necessary information includes information such as the request for failure restoration work, the model number and the serial number of the recording device 1, the error code, the failure occurrence date and time, the location where the recording device 1 is installed, the user contact, and the like.

The controller 31 of the worker terminal 30 displays the received necessary information on the touch panel 32. Further, the controller 31 of the worker terminal 30 transmits, to the worker selection server 20, the remark indicating that the necessary information has been received. In the embodiment, it is basically assumed that the worker accepts the work when the worker terminal 30 receives the above necessary information, but the worker may accept the work when the worker inputs, to the worker terminal 30, the remark indicating that the work has been accepted, and transmitting it to the worker selection server 20. Functions and effects of worker selection system

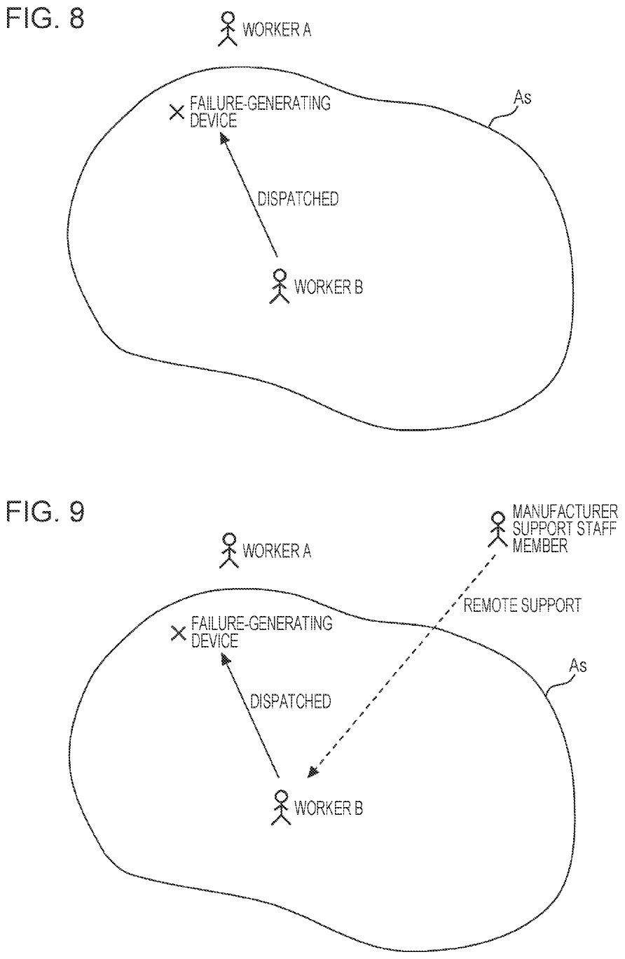

FIGS. 8 and 9 are diagrams conceptually showing the positional relationship between the worker selected by the worker selection system 50 according to the present embodiment and the failure-generating device, and the reference numeral As shows the setting area including the location of the failure-generating device. In FIG. 8, both the worker A and the worker B are workers who satisfy the failure restoration condition, and the worker A is closer to the location of the failure-generating device than the worker B. However, since the worker A is outside the setting area As, the worker A is not selected as a candidate to be dispatched, and the worker B inside the setting area As is selected as a candidate to be dispatched.

Further, in FIG. 9, both worker A and worker B are workers who satisfy the failure restoration conditions, the worker A has the skill to restore a failure independently, and the worker B needs remote support from a manufacturer support staff member. The worker A is closer to the location of the failure-generating device than the worker B, but since the worker A is outside the setting area As, the worker A is not selected as a candidate to be dispatched, and the worker B inside the setting area As is selected as a candidate to be dispatched.

As described above, the worker selection system 50 is a worker selection system that selects a worker who performs restoration work on a device that failed, where the system includes a failure information reception unit (the controller 11 of the manufacturer management server 10) that receives failure information including information about a content of the failure and information about an identification of the device, a worker information storage unit (the storage unit 24 of the worker selection server 20) that stores worker information including information about a failure handling ability of the worker (the worker ability table T3) and information about a location of the worker (the worker basic table T2), an area information storage unit (the storage unit 24 of the worker selection server 20) that stores area information about a setting area (the setting area table T5) that includes a location of the device and, a worker selection unit (the worker selection unit 27) that selects, based on the worker information and the area information, the worker who has an ability to handle the failure and is present in the setting area as a candidate to be dispatched.

Further, a worker selection method in the worker selection system 50 includes receiving failure information including information about a content of the failure and information about an identification of the device (step S301 in FIG. 7), and selecting, based on worker information including information about a failure handling ability of the worker (the worker ability table T3) and information about a location of the worker (the worker basic table T2), and area information about a setting area including a location of the device and changing depending on a setting (the setting area table T5), the worker who has an ability to handle the failure and is present in the setting area as a candidate to be dispatched (step S302 in FIG. 7).

Further, the worker selection unit 27, which is a worker selection program, is a worker selection program causing the worker selection server 20 to select a worker who performs restoration work on a device that failed, and causing the server to execute a method, where the method includes receiving failure information including information about a content of the failure and information about an identification of the device (step S301 in FIG. 7), and selecting, based on worker information including information about a failure handling ability of the worker (the worker ability table T3) and information about a location of the worker (the worker basic table T2), and area information about a setting area including a location of the device and changing depending on a setting (the setting area table T5), the worker who has an ability to handle the failure and is present in the setting area as a candidate to be dispatched (step S302 in FIG. 7).

As described above, according to the worker selection system 50, it is possible to suppress the dispatch of the worker from an area that is unfavorable to the user of the device that failed or the manufacturer of the device that failed, and dispatch a suitable worker.

Further, in the present embodiment, the worker includes a manufacturer worker who belongs to the manufacturer of the device to be restored and a non-manufacturer worker who does not belong to the manufacturer of the device. As a result, it is possible to select the candidate to be dispatched from a larger number of workers, and as a result, a more appropriate worker can be selected.

Further, when the non-manufacturer worker present in the setting area is allowed to handle the failure by receiving remote support, the worker selection unit 27 selects the non-manufacturer worker as a candidate to be dispatched, so that the non-manufacturer worker can be a candidate to be dispatched by supplementing the failure handling ability of the non-manufacturer worker, and the range of worker selection can be expanded.

Further, when a non-manufacturer worker receives remote support, the non-manufacturer worker may image the surroundings of the device by using the camera, so that the imaging may be unfavorable for the user of the device in terms of security. However, according to this aspect, the information about the worker transmitted by the worker selection server 20 to the user terminal 40 includes a remark indicating that the worker receives remote support, so that the user who does not like the remote support can be notified of the remark, and it is possible to take the intention of the user into consideration.

Further, in the above embodiment, the setting area is an area set for infectious disease countermeasures. This makes it possible to select an appropriate worker from the viewpoint of infectious disease countermeasures. Modifications

The above-mentioned embodiment can be modified as follows.

(1) The manufacturer management server 10 and the worker selection server 20 may be the same server, and in this case, one server constitutes the worker selection system. Further, both the manufacturer management server 10 and the worker selection server 20 may be owned and managed by the manufacturer A. Further, the restoration condition data 15 included in the manufacturer management server 10 may be provided in another server. In this case, the controller 11 of the manufacturer management server 10 acquires the restoration condition data 15 from another server. Further, either one or both of the worker data 25 and the area information data 26 included in the worker selection server 20 may be provided in the manufacturer management server 10 or another server. In this case, the controller 21 of the worker selection server 20 acquires the worker data 25 and the area information data 26 from another server.

(2) The worker data 25 may be divided into the data of the manufacturer worker and the data of the non-manufacturer worker. At this time, the data of the manufacturer worker may be provided in the manufacturer management server 10 or another server, and the data of the non-manufacturer worker may be provided in the worker selection server 20 or another server. In this case, the controller 21 of the worker selection server 20 acquires the data of the manufacturer worker and the data of the non-manufacturer worker independently.

(3) The setting area is an area set for infectious disease countermeasures in the above embodiment, but is not limited to this, and may be set from the viewpoint of customer management reasons and work base load equality, for example. More specifically, for example, it is conceivable to define the setting area so that the number of customers whom one work base is in charge of is as uniform as possible. The setting area may be set by the user. In this case, the recording device 1 may hold information about the setting area and transmit the information to the manufacturer management server 10 when a failure occurs.

(4) Information about the qualification owned by the worker and whether the failure similar to the failure that has occurred was solved in the past may be displayed based on the worker data 25 in the candidate to be dispatched list displayed on the touch panel 42 of the user terminal 40. Further, the gender of the worker, the user's evaluation of the past work, and the like as the worker data 25 may be saved and displayed on the touch panel 42 of the user terminal 40.

(5) Costs incurred may be calculated and presented to the user for each worker in the candidate to be dispatched list displayed on the touch panel 42 of the user terminal 40. For example, it is possible to set the incurred costs higher for a worker dispatched from a greater distance, and set the incurred costs higher for a worker with a higher ability.

(6) When selecting a worker as candidate to be dispatched, it may be possible to invalidate the selection of the worker based on the setting area by the user setting. In this case, a worker as a candidate to be dispatched may be selected based on a factor that the user gives priority to, such as the time for the worker to arrive.

(7) When the user of the device does not own the user terminal 40, the controller 21 of the worker selection server 20 may transmit the candidate to be dispatched list to the manufacturer management server 10. In this case, the operator of the manufacturer A and the user of the device exchange information by using a communication means such as a telephone, and determine a worker to be dispatched.

(8) In the above embodiment, the recording device 1 is mentioned as an example of the device, but the device is not limited to this, and of course, the embodiment can be applied to the failure restoration work of other devices, and can be applied not only to the restoration work of the device that failed but also to another work.

Further, the present disclosure is not limited to the above embodiment, and various modifications can be made within the scope of the disclosure described in the claims, and they are also included in the scope of the present disclosure.

What is claimed is:

1. A worker selection system that selects a worker who performs restoration work on a device that failed, the system comprising:
a failure information reception unit that receives failure information including information about a content of the failure and information about an identification of the device;
a worker information storage unit that stores worker information including information about a failure handling ability of the worker and information about a location of the worker;
an area information storage unit that stores area information about a setting area including a location of the device and changing depending on a setting; and
a worker selection unit that selects, based on the worker information and the area information, the worker who has an ability to handle the failure and is present in the setting area as a candidate to be dispatched.

2. The worker selection system according to claim 1, wherein
the worker includes a manufacturer worker who belongs to a manufacturer of the device and a non-manufacturer worker who does not belong to the manufacturer of the device.

3. The worker selection system according to claim 2, wherein
when the non-manufacturer worker present in the setting area is allowed to handle the failure by receiving remote support, the worker selection unit selects the non-manufacturer worker as the candidate to be dispatched.

4. The worker selection system according to claim 3, wherein
the worker selection server including the worker selection unit is allowed to transmit information about the worker selected as the candidate to be dispatched to an information terminal of a user who is a user of the device, and wherein
the information about the worker to be transmitted to the information terminal of the user includes a remark indicating that the worker receives remote support.

5. The worker selection system according to claim 1, wherein
the setting area is an area set for infectious disease countermeasures.

6. The worker selection system according to claim 2, wherein
the setting area is an area set for infectious disease countermeasures.

7. The worker selection system according to claim 3, wherein
the setting area is an area set for infectious disease countermeasures.

8. The worker selection system according to claim 4, wherein
the setting area is an area set for infectious disease countermeasures.

9. A worker selection method of selecting a worker who performs restoration work on a device that failed, the method comprising:
receiving failure information including information about a content of the failure and information about an identification of the device; and
selecting, based on worker information including information about a failure handling ability of the worker and information about a location of the worker, and area information about a setting area including a location of the device and changing depending on a setting, the worker who has an ability to handle the failure and is present in the setting area as a candidate to be dispatched.

10. A non-transitory computer-readable storage medium storing a worker selection program, the program causing a computer to select a worker who performs restoration work on a device that failed, and causing the computer to execute a method, the method comprising:
receiving failure information including information about a content of the failure and information about an identification of the device; and
selecting, based on worker information including information about a failure handling ability of the worker and information about a location of the worker, and area information about a setting area including a location of the device and changing depending on a setting, the worker who has an ability to handle the failure and is present in the setting area as a candidate to be dispatched.
